(19) United States
(12) Patent Application Publication
(10) Pub. No.: US 2010/0152359 A1
(43) Pub. Date: Jun. 17, 2010

(54) Environmentally Sound Thermoplastic Resin Composition Using Recycled Polyester Resin

(75) Inventors: Jee Kwon PARK, Uiwang-si (KR); Jin Hwan CHOI, Uiwang-si (KR); Kang Yeol PARK, Uiwang-si (KR); Jun Myung KIM, Uiwang-si (KR); Jae Won LEE, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Cheil Industries Inc.

(21) Appl. No.: 12/627,198

(22) Filed: Nov. 30, 2009

(30) Foreign Application Priority Data
Dec. 11, 2008 (KR) 2008-125692

(51) Int. Cl. C08L 51/00; C08G 63/91

(52) U.S. Cl. 524/504; 525/64

(57) ABSTRACT

An environmentally sound thermoplastic resin composition using a recycled polyester resin according to the present invention comprises (A) 1 to 98 parts by weight of a recycled polyester resin; (B) 1 to 80 parts by weight of a modified aromatic vinyl-vinyl cyanide copolymer resin comprising a functional group capable of reacting with polyester; and (C) 98 to 1 part by weight of an aromatic vinyl graft copolymer resin.

### CROSS REFERENCE TO RELATED APPLICATIONS

This application claims priority from Korean Patent Application No. 2008-125692 filed on Dec. 11, 2008 in the Korean Intellectual Property Office, the disclosure of which is incorporated herein by reference in its entirety.

### FIELD OF THE INVENTION

The present invention relates to an environmentally sound thermoplastic resin composition including a recycled polyester resin.

### BACKGROUND OF THE INVENTION

The treatment of plastic waste generated from industrial and domestic use is a serious problem. Although the plastic waste can be separated and collected, it is almost impossible to properly recycle the plastic waste. Such plastic waste has typically been buried in landfills. However, it is increasingly difficult to select a landfill, and various environmental problems including water pollution can result even when the plastic waste is buried in a landfill.

Recycling plastic waste and using the recycled plastic as raw materials for new plastic products has been attempted to prevent water pollution and soil pollution due to reclamation, solve difficulties associated with the selection of landfills, and save money by providing an alternative source of plastic materials for new products for imported plastic raw materials. Further, there has been a focus on the development of environmentally sound resins in view of recent policies in European countries limiting the use of harmful substances that may cause environmental pollution problems and making it compulsory to use recycled products. One method to recycle polyester waste forms the polyester waste into small pieces or pellets.

Since polyester resins have short molecular chains that are not easily bent, polyester resins have good rigidity, electrical properties, weatherability and heat resistance, and low deterioration in tensile strength even upon exposure to high temperatures for a long time. Further, polyester resins have good resistance to chemicals such as industrial oils since the polyester resins are crystalline. However, workability and impact resistance of polyester resin can be lowered due to their crystalline nature. Further, mechanical properties such as impact resistance can be deteriorated since recycled polyester has a low molecular weight following pulverization during the recycling of the polyester waste.

One method to maintain chemical resistance and impact resistance of polyester resin includes alloying acrylonitrile butadiene styrene (ABS) resins and polyester resins. However ABS and polyester resin alloys can require complicated drying and molding conditions since polyester is decomposed by water at high temperatures.

There is a limit to the ability to provide sufficiently stable physical properties in injection and extrusion molding processes because of limited compatibility between recycled polyester and ABS resins. In particular, when recycled polyester and ABS resins are injection or extrusion molded, the respective resin phases can agglomerate to increase phase sizes since the compatibility of the alloyed resins deteriorates at high temperatures and resistance to phase separation is reduced due to melt viscosity deterioration of the ABS resins or recycled polyester. As the phase sizes increase, impact strength of the resin compositions decreases, and differences between the physical properties in a molding direction and a direction perpendicular thereto further increase. There is a limit on compatibility, and even adding styrene acrylonitrile (SAN) resin to promote compatibility between the recycled polyester and ABS resin is not expected to improve physical properties except moldability. In addition, an impact modifier should necessarily be added to blends of the recycled polyester and ABS resins in order to maintain notched impact resistance or surface impact strength, which is a further disadvantage of recycled polyester/ABS blends.

### SUMMARY OF THE INVENTION

The present invention provides an environmentally sound thermoplastic resin composition using a recycled polyester resin.

The present invention further provides an environmentally sound thermoplastic resin composition that can have an excellent balance of physical properties such as chemical resistance and impact resistance.

The present invention further provides an environmentally sound thermoplastic resin composition that can have excellent chemical resistance and impact resistance so that the thermoplastic resin composition can be used in the production of various products such as interior and exterior materials or structural materials for electric and electronic appliances.

In an exemplary aspect the present invention is an environmentally sound thermoplastic resin composition including a recycled polyester resin, a modified aromatic vinyl-vinyl cyanide copolymer resin comprising functional groups capable of reacting with polyester, and an aromatic vinyl graft copolymer resin.

In an exemplary embodiment, the environmentally sound thermoplastic resin composition comprises: (A) about 1 to about 98 parts by weight of a recycled polyester resin; (B) about 1 to about 80 parts by weight of a modified aromatic vinyl-vinyl cyanide copolymer resin; and (C) about 98 to about 1 part by weight of an aromatic vinyl graft copolymer resin. In another exemplary embodiment, the environmentally sound thermoplastic resin composition comprises: (A) about 10 to about 45 parts by weight of a recycled polyester resin; (B) about 5 to about 30 parts by weight of a modified aromatic vinyl-vinyl cyanide copolymer resin; and (C) about 50 to about 80 parts by weight of an aromatic vinyl graft copolymer resin.

In an exemplary embodiment, the recycled polyester resin (A) can have an intrinsic viscosity of about 0.4 to about 1.5 g/dL.

In an exemplary embodiment, the modified aromatic vinyl-vinyl cyanide copolymer resin (B) is a copolymer comprising (b1) about 0.01 to about 5 mole percent (%) of maleic anhydride, maleic acid, an unsaturated compound represented by the following Chemical Formula 1, or a combination thereof; and (b2) about 95 to about 99.99 mole % of a vinyl-based compound:

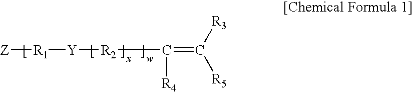

wherein each of R₃, R₄ and R₅ independently comprises H, saturated or unsaturated C1-C12 alkyl, C6-C14 aryl, saturated or unsaturated C1-C12 alkyl-substituted C6-C14 aryl, carboxyl, phenoxy, or hydroxy;

Y is ether (—O—), carboxyl (—O—[C═O]—, —[O═C]—O—), C1-C12 alkylene, C6-C14 arylene, or saturated or unsaturated C1-C12 alkyl-substituted C6-C14 arylene;

each x and w is independently 0 or 1;

Z is H, epoxy, carboxylic acid, isocyanate, oxadiazole, amine, or hydroxy,

wherein if Y is ether (—O—) or carboxyl (—O—[C═O]—, —[O═C]—O—), each R₁ and R₂ independently comprises C1-C12 alkylene, C6-C14 arylene, or saturated or unsaturated C1-C12 alkyl-substituted C6-C14 arylene,

and if Y is C1-C12 alkylene, C6-C14 arylene or saturated or unsaturated C1-C12 alkyl-substituted C6-C14 arylene, Y is represented by (R₁—Y—R₂).

In an exemplary embodiment, the unsaturated compound may comprise an epoxy group-comprising monomer such as but not limited to epoxy alkyl acrylate, allyl glycidyl ester, aryl glycidyl ester, glycidyl methacrylate, glycidyl acrylate, butadiene monoxide, vinyl glycidyl ether, or glycidyl itaconate; a carboxylic acid group-comprising monomer such as but not limited to acrylic acid, methacrylic acid, 2-butenoic acid, 2-methyl-2-butenoic acid, undecylenic acid, oleic acid, sorbic acid, linoleic acid, crotonic acid, or itaconic acid; an isocyanate group-comprising monomer such as but not limited to vinyl isocyanate, acryl isocyanate, or methacryl isocyanate; an amine group-comprising monomer such as but not limited to vinyl amine, acryl amine, or methacryl amine; a hydroxy group-comprising monomer hydroxy vinyl ether, hydroxy ethyl acrylate, hydroxy ethyl methacrylate, hydroxy propyl acrylate, hydroxy propyl methacrylate, or 2-hydroxy-3-phenoxypropyl acrylate; or a combination thereof.

In an exemplary embodiment, the aromatic vinyl graft copolymer resin (C) comprises about 10 to about 100% by weight of a graft copolymer resin (c1) and about 0 to about 90% by weight of a copolymer resin (c2). In another exemplary embodiment, the aromatic vinyl graft copolymer resin (C) comprises about 55 to about 90% by weight of a graft copolymer resin (c1) and about 10 to about 45% by weight of a copolymer resin (c2).

In an exemplary embodiment, the graft copolymer resin (c1) may be a graft copolymer obtained by polymerizing about 5 to about 65% by weight of a rubber-like polymer with a monomer mixture comprising about 34 to about 94% by weight of an aromatic vinyl monomer and about 1 to about 30% by weight of a vinyl cyanide monomer. The copolymer resin (c2) may be a copolymer obtained by polymerizing a monomer mixture comprising about 70 to about 95% by weight of an aromatic vinyl monomer and about 5 to about 30% by weight of a vinyl cyanide monomer. Also, the rubber-like polymer may have a particle size of about 0.1 to about 6 μm.

In an exemplary embodiment, the resin composition may further comprise a thickener. The resin composition may include the thickener in an amount of about 0.001 to about 5 parts by weight based on about 100 parts by weight of the recycled polyester. In an exemplary embodiment, the thickener may have two or more functional groups such as but not limited to an epoxy group, maleic anhydride, maleic acid, an amine group, and the like, and combinations thereof. In an exemplary embodiment, the thickener can include triglycidyl isocyanurate, methylene diphenyl diisocyanate, isophorone diisocyanate, toluene diisocyanate, or a combination thereof.

In an exemplary embodiment, the resin composition may further comprise one or more additives. Exemplary additives may include without limitation flame retardants, lubricants, release agents, antistatic agents, dispersants, anti-dripping agents, impact modifiers, antioxidants, plasticizers, heat stabilizers, light stabilizers, weather resistant stabilizers, compatibilizers, pigments, dyestuffs, inorganic filler and the like, and combinations thereof.

According to another aspect of the present invention, there is provided a molded article manufactured by molding the aforementioned environmentally sound thermoplastic resin composition. Exemplary molded articles can include without limitation pellets, components of electric and electronic appliances, exterior materials, car components, miscellaneous goods, structural materials, and the like.

In an exemplary embodiment, the molded article can have an Izod impact strength of about 40 kgf·cm/cm or more measured in accordance with ASTM D-256 for a specimen with a thickness of ⅛″, and a cracking strain (ε) of the specimen of about 1.3% or more when engine oil is applied to a ¼ oval jig for about 24 hours.

According to a further aspect of the present invention, there is provided a method for preparing an environmentally sound thermoplastic resin using a recycled polyester resin. The aforementioned method comprises the steps of mixing about 1 to about 98 parts by weight of a recycled polyester resin, about 1 to about 80 parts by weight of a modified aromatic vinyl-vinyl cyanide copolymer resin comprising functional groups capable of reacting with polyester and about 98 to about 1 part by weight of an aromatic vinyl graft copolymer resin, and extruding the mixture.

In an exemplary embodiment, the recycled polyester resin may have an intrinsic viscosity of about 0.4 to about 1.5 g/dL.

In another exemplary embodiment, an intrinsic viscosity of the recycled polyester resin may be more than about 0 g/dL and less than about 0.4 g/dL. If a polyester resin with an intrinsic viscosity of less than about 0.4 g/dL is used as a raw material, the intrinsic viscosity of the polyester resin can be controlled to about 0.4 to about 1.5 g/dL by mixing a thickener with the polyester resin and extruding the mixture.

### BRIEF DESCRIPTION OF THE DRAWING

FIG. 1 is a graph illustrating the test described in the examples for determining chemical resistance of a specimen to an organic solvent, in which “a” is the length (in mm) of a long axis of a measuring instrument, “b” is the length (in mm) of a short axis of a measuring instrument, and “x” is the cracking length (in mm) of a specimen from the short axis.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The present invention provides an environmentally sound thermoplastic resin composition comprising (A) a recycled polyester resin, (B) a modified aromatic vinyl-vinyl cyanide copolymer resin, and (C) an aromatic vinyl graft copolymer resin.

(A) Recycled Polyester Resin

In the present invention, recycled polyester may be obtained from various products, such as polyethylene terephthalate (PET) bottles, polybutylene terephthalate (PBT), polyester fibers, polyester films, and the like, and combinations thereof. Exemplary recycled polyester capable of being used in the present invention may include without limitation polyethylene terephthalate, polybutylene terephthalate, polyethylene naphthalate, polybutylene naphthalate, polypropylene terephthalate, polyethylene terephthalate glycol and the like, and combinations thereof but the present invention is not necessarily limited thereto.

In an exemplary embodiment, the recycled polyester resin (A) can have an intrinsic viscosity of about 0.4 to about 1.5 g/dL. If the intrinsic viscosity of the recycled polyester resin (A) is about 0.4 g/dL or more, excellent impact strength and chemical resistance can be obtained. If the intrinsic viscosity thereof is about 1.5 g/dL or less, process problems may not be generated. The intrinsic viscosity of the recycled polyester resin can be, for example, about 0.5 to about 1.2 g/dL, and as another example about 0.6 to about 1.0 g/dL.

Recycled polyester resins obtained from PET bottles, polyester extrusion molded articles, polyester injection molded articles, and the like usually have an intrinsic viscosity of about 0.4 g/dL or more. Such recycled polyester having an intrinsic viscosity of about 0.4 to about 1.5 g/dL may be used as a raw material as is or after washing and pulverization. Further, the recycled polyester may be used after processing it in the form of pellets through extrusion.

On the other hand, recycled polyester obtained from polyester fibers, polyester films, and the like usually has an intrinsic viscosity of less than about 0.4 g/dL. If such recycled polyester having an intrinsic viscosity of less than about 0.4 g/dL is used, the molecular weight reduction in the process may make it difficult to provide desired mechanical properties. Therefore, when recycled polyester with an intrinsic viscosity of less than about 0.4 g/dL is used as a raw material, it may be used after increasing the intrinsic viscosity to about 0.4 to about 1.5 g/dL. In an exemplary embodiment, the recycled polyester with an intrinsic viscosity less than about 0.4 g/dL can be mixed with a thickener to provide a recycled polyester with an intrinsic viscosity of about 0.4 to about 1.5 g/dL and the mixture of the recycled polyester and thickener can be extruded.

Exemplary thickeners include without limitation compounds which have two or more functional groups capable of reacting with a carboxyl group and a hydroxy group of polyester and can link polyester polymer chains. The functional groups are not particularly limited, but examples thereof can include without limitation epoxy groups, maleic anhydride, maleic acid, amine groups, and the like, and combinations thereof. In an exemplary embodiment, the thickener may comprise triglycidyl isocyanurate, methylene diphenyl diisocyanate, isophorone diisocyanate, toluene diisocyanate, or a combination thereof. The thickener may be used in the amount of about 0.001 to about 5 parts by weight, for example about 0.005 to about 2.5 parts by weight, as another example about 0.01 to about 1 part by weight, based on about 100 parts by weight of recycled polyester. In an exemplary embodiment, after mixing recycled polyester with a thickener, the mixture may be extruded at a temperature of about 160 to about 280° C. in an ordinary twin screw extruder to manufacture pellets so that the manufactured pellets can be used.

The thermoplastic resin composition of the invention may include the recycled polyester resin (A) in an amount of about 1 to about 98 parts by weight, for example about 10 to about 80 parts by weight, as another example about 20 to about 60 parts by weight, and as another example about 25 to about 50 parts by weight, based on the total weight of a composition of (A), (B), and (C). If the recycled polyester resin (A) is used in the foregoing amounts, the composition may have a balance of physical properties such as impact strength and chemical resistance. In another exemplary embodiment, the recycled polyester resin (A) may be used in an amount of about 10 to about 45 parts by weight, based on the total weight of a composition of (A), (B), and (C).

(B) Modified Aromatic Vinyl-Vinyl Cyanide Copolymer Resin

The modified aromatic vinyl-vinyl cyanide copolymer resin of the present invention comprises a functional group capable of reacting with polyester.

In an exemplary embodiment, the modified aromatic vinyl-vinyl cyanide copolymer resin (B) is a resin prepared by polymerizing a vinyl-based resin such that a functional group capable of reacting with polyester is present in the vinyl-based resin.

In an exemplary embodiment of the present invention, the modified aromatic vinyl-vinyl cyanide copolymer resin (B) is a copolymer of an unsaturated compound (b1) and a vinyl-based compound (b2). In an exemplary embodiment, the modified aromatic vinyl-vinyl cyanide copolymer resin (B) is a copolymer of (b1) about 0.01 to about 5 mole % of an unsaturated compound and (b2) about 95 to about 99.99 mole % of a vinyl-based compound.

In the present invention, the resin composition can include the modified aromatic vinyl-vinyl cyanide copolymer resin (B) in an amount of about 1 to about 80 parts by weight, for example about 5 to about 60 parts by weight, as another example about 10 to about 50 parts by weight, and as another example about 20 to about 40 parts by weight, based on the total weight of a composition of (A), (B), and (C). If the modified aromatic vinyl-vinyl cyanide copolymer resin (B) is used in the foregoing amounts, a balance of physical properties such as impact strength and chemical resistance may be obtained. In another exemplary embodiment, the modified aromatic vinyl-vinyl cyanide copolymer resin (B) may be used in an amount of about 5 to about 30 parts by weight, based on the total weight of a composition of (A), (B), and (C).

(b1) Unsaturated Compound

The unsaturated compound used in the modified aromatic vinyl-vinyl cyanide copolymer resin of the present invention may include maleic anhydride, maleic acid, a compound represented by the following Chemical Formula 1, or the like, or a combination thereof:

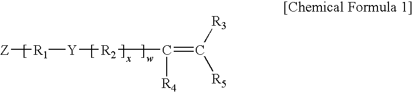

wherein each of R₃, R₄ and R₅ independently comprises H, saturated or unsaturated C1-C12 alkyl, C6-C14 aryl, saturated or unsaturated C1-C12 alkyl-substituted C6-C14 aryl, carboxyl, phenoxy, or hydroxy;

Y is ether (—O—), carboxyl (—O—[C═O]—, —[O═C]—O—), C1-C12 alkylene, C6-C14 arylene, or saturated or unsaturated C1-C12 alkyl-substituted C6-C14 arylene;

each of x and w is 0 or 1;

Z is H, epoxy, carboxylic acid, isocyanate, oxadiazole, amine, or hydroxy,

wherein if Y is ether (—O—) or carboxyl (—O—[C═O]—, —[O═C]—O—), each R₁ and R₂ independently comprises C1-C12 alkylene, C6-C14 arylene, or saturated or unsaturated C1-C12 alkyl-substituted C6-C14 arylene,

and if Y is C1-C12 alkylene, C6-C14 arylene, or saturated or unsaturated alkyl-substituted C6-C14 arylene, Y is represented by (R₁—Y—R₂).

Exemplary unsaturated compounds may include one or more of: an epoxy group-comprising monomer such as but not limited to epoxy alkyl acrylate, allyl glycidyl ester, aryl glycidyl ester, glycidyl methacrylate, glycidyl acrylate, butadiene monoxide, vinyl glycidyl ether, glycidyl itaconate, and the like; a carboxylic acid group-comprising monomer such as but not limited to acrylic acid, methacrylic acid, 2-butenoic acid, 2-methyl-2-butenoic acid, undecylenic acid, oleic acid, sorbic acid, linoleic acid, crotonic acid, itaconic acid, and the like; an isocyanate group-comprising monomer such as but not limited to vinyl isocyanate, acryl isocyanate, methacryl isocyanate, and the like; an amine group-comprising monomer such as but not limited to vinyl amine, acryl amine, methacryl amine, and the like; a hydroxy group-comprising monomer such as but not limited to hydroxy vinyl ether, hydroxy ethyl acrylate, hydroxy ethyl methacrylate, hydroxy propyl acrylate, hydroxy propyl methacrylate, 2-hydroxy-3-phenoxypropyl acrylate, and the like; and combinations thereof. However, the unsaturated compound is not necessarily limited to the foregoing examples. The unsaturated compound may be used singly or in the form of a combination of two or more thereof.

The unsaturated compound (b1) can be added in an amount of about 0.01 to about 5 mole % in the form of a monomer for the copolymerization. If the unsaturated compound (b1) is added in the foregoing amount, an effect of improving the impact strength may be obtained in the optimal range, and the generation of gelation phenomena may be minimized during extrusion.

(b2) Vinyl-Based Compound

The vinyl-based compound (b2) used in the modified aromatic vinyl-vinyl cyanide copolymer resin (B) of the present invention comprises an aromatic vinyl monomer and a monomer capable of copolymerizing with the aromatic vinyl monomer.

In an exemplary embodiment, the aromatic vinyl monomer has a structure represented by the following Chemical Formula 2:

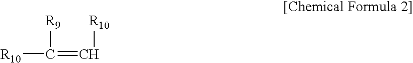

wherein R₉ is hydrogen or methyl; R₁₀ is phenyl, halophenyl, C1-C10 alkylphenyl, C1-C10 alkylhalophenyl, naphthalene, or C1-C10 alkylnaphthalene; and R₁₁ is hydrogen or methyl.

In the above Chemical Formula 2, the halophenyl is a phenyl substituted with one to three halogen compounds, the alkylphenyl is a phenyl substitute with one or two alkyl, the alkylhalophenyl is a phenyl group substituted with alkyl containing a halogen or a phenyl group substituted with halogen and alkyl, and the alkylnaphthalene group is a naphthalene group substituted with one to four alkyl groups.

Exemplary aromatic vinyl monomers may include without limitation styrene, α-methylstyrene, β-methylstyrene, p-methylstyrene, para-t-butylstyrene, ethylstyrene, vinyl xylene, monochlorostyrene, dichlorostyrene, dibromostyrene, vinylnaphthalene, and the like, and combinations thereof. The aromatic vinyl monomer, however, is not necessarily limited to the foregoing. The aromatic vinyl monomer may be used singly or in the form of a combination of two or more thereof.

Exemplary monomers capable of copolymerizing with the aromatic vinyl monomer may include without limitation vinyl cyanide monomers such as acrylonitrile, methacrylonitrile, ethacrylonitrile, and the like, and combinations thereof, but the monomer is not necessarily limited thereto. The monomers capable of copolymerizing with the aromatic vinyl monomer may be used singly or in the form of a combination of two or more thereof.

A ratio of the aromatic vinyl monomer and the monomer capable of copolymerizing with the aromatic vinyl monomer can be determined based on compatibility and a ratio of monomers except rubber in components of the aromatic vinyl graft copolymer resin (C). The vinyl-based compound (b2) can include about 50 to about 99% by weight of an aromatic vinyl monomer and about 1 to about 50% by weight of a monomer capable of copolymerizing with the aromatic vinyl monomer. As another example, the vinyl-based compound (b2) can include about 60 to about 90% by weight of an aromatic vinyl monomer and about 10 to about 40% by weight of a monomer capable of copolymerizing with the aromatic vinyl monomer. In the foregoing amounts, desirable effects in terms of workability and strength can be obtained.

The vinyl-based compound (b2) of the present invention may optionally further comprise an ethylenically unsaturated monomer to thereby improve properties of a copolymer, such as workability, heat resistance, and the like. Exemplary ethylenically unsaturated monomers may include without limitation (meth)acrylic acid esters such as C1-C4 alkyl methacrylate such as methyl methacrylate, phenyl acrylate, phenyl methacrylate, benzyl acrylate, benzyl methacrylate, 2-phenylethyl acrylate, 2-phenylethyl methacrylate, 2-phenoxyethyl acrylate, 2-phenoxyethyl methacrylate, and the like; N-substituted maleimides, such as N-methylmaleimide, N-phenylmaleimide, N-cyclohexylmaleimide, and the like; unsaturated dicarboxylic acids such as maleic acid, fumaric acid, itaconic acid, and the like, and anhydrides thereof; unsaturated carboxylic acids such as acrylic acid, methacrylic acid, and the like; nitrogen-functional monomers, such as dimethylaminoethyl acrylate, diethylaminoethyl acrylate, vinylimidazole, vinylpyrrolidone, vinyl caprolactam, vinylcarbazole, vinylaniline, acrylamide, methacrylamide, and the like; and combinations thereof. The ethylenically unsaturated monomer is not necessarily limited thereto. The ethylenically unsaturated monomer may be added in an amount of more than about 0% by weight and not more than about 30% by weight, for example about 1 to about 20% by weight, and as another example about 2 to about 15% by weight, with respect to the total weight of the vinyl-based compound (b2).

(C) Aromatic Vinyl Graft Copolymer Resin

The aromatic vinyl graft copolymer resin according to the present invention is a polymer in which a rubber-like polymer is dispersed and present in the form of particles in a matrix (continuous phase) formed from an aromatic vinyl polymer. The aromatic vinyl graft copolymer resin can be polymerized after adding the rubber-like polymer to an aromatic vinyl monomer and optionally a monomer capable of copolymerizing with the aromatic vinyl monomer. Such an aromatic vinyl graft copolymer resin may be prepared by known-polymerization methods including emulsion polymerization, suspension polymerization, and bulk polymerization, and the aromatic vinyl graft copolymer resin is usually prepared by mixing a graft copolymer resin with a copolymer resin and extruding the mixture. In the case of bulk polymerization, the aromatic vinyl graft copolymer resin can be prepared by a one-step reaction process without separately preparing the graft copolymer resin and copolymer resin. However, regardless of the method used, the final aromatic vinyl graft copolymer resin (C) can include about 5 to about 65% by weight of the rubber.

Exemplary aromatic vinyl graft copolymer resins (C) used in the present invention may include without limitation acrylonitrile-butadiene-styrene copolymer resins (ABS resins), acrylonitrile-ethylene/propylene rubber-styrene copolymer resins (AES resins), acrylonitrile-acrylic rubber-styrene copolymer resins (AAS resins), and the like, and combinations thereof.

The rubber phase can have an Z-average particle size of about 0.1 to about 6.0 μm, for example about 0.25 to about 3.5 μm, which can promote desired physical properties when alloying an aromatic vinyl graft copolymer resin and a polyester resin in the present invention.

In the present invention, the thermoplastic resin can include the aromatic vinyl graft copolymer resin (C) in an amount of about 1 to about 98 parts by weight, for example about 10 to about 80 parts by weight, as another example about 15 to about 60 parts by weight, and as another example about 20 to about 50 parts by weight, based on the total weight of a composition of (A), (B), and (C). If the aromatic vinyl graft copolymer resin (C) is used in the foregoing amounts, it is possible to obtain excellent impact resistance, chemical resistance and hydrolysis resistance.

The aromatic vinyl graft copolymer resin (C) used in the present invention may be prepared by using the graft copolymer resin solely or using the graft copolymer resin and copolymer resin together. In exemplary embodiments of the invention the graft copolymer resin can be mixed with a copolymer resin to promote compatibility.

In an exemplary embodiment, the aromatic vinyl graft copolymer resin (C) used in the present invention can be a mixture of about 10 to about 100% by weight of a graft copolymer resin (c1) and about 0 to about 90% by weight of a copolymer resin (c2). For example, the aromatic vinyl graft copolymer resin (C) can be a mixture of about 20 to about 90% by weight of the graft copolymer resin (c1) and about 10 to about 80% by weight of the copolymer resin (c2). As another example, the aromatic vinyl graft copolymer resin (C) can be a mixture of about 50 to about 85% by weight of the graft copolymer resin (c1) and about 15 to about 50% by weight of the copolymer resin (c2).

(c1) Graft Copolymer Resin

A graft copolymer resin (c1) of the present invention can be obtained by graft copolymerizing a rubber-like polymer, an aromatic vinyl monomer, a vinyl cyanide monomer, and optionally a monomer imparting workability and heat resistance.

Exemplary rubber-like polymers may include without limitation diene-based rubbers, such as polybutadiene, poly(styrene-butadiene), poly(acrylonitrile-butadiene) and the like, saturated rubbers in which hydrogen is added in the diene-based rubbers, isoprene rubbers, acrylic rubbers such as polybutyl acrylate and the like, ethylene-propylene-diene terpolymer (EPDM), and the like, and combinations thereof. The amount of the rubber-like polymer can be about 5 to about 65% by weight, for example about 10 to about 65% by weight, based on the total weight of the graft copolymer resin (c1). The rubber-phased polymers can have an average rubber particle size of about 0.1 to about 4 μm based on desired impact strength and external appearance of the rubber-phased polymers.

Exemplary aromatic vinyl monomers may include without limitation styrene, α-methylstyrene, β-methylstyrene, p-methylstyrene, para-t-butylstyrene, ethylstyrene, vinyl xylene, monochlorostyrene, dichlorostyrene, dibromostyrene, vinylnaphthalene, and the like, and combinations thereof. The aromatic vinyl monomer, however, is not necessarily limited thereto. The aromatic vinyl monomer may be used singly or in the form of a combination of two or more thereof. The graft copolymer resin (c1) can include the aromatic vinyl monomer in an amount of about 34 to about 94% by weight, for example about 40 to about 90% by weight, based on the total weight of the graft copolymer resin (c1).

Exemplary vinyl cyanide monomers may include without limitation acrylonitrile, ethacrylonitrile, methacrylonitrile, and the like, and combinations thereof. The vinyl cyanide monomer may be used singly or in the form of a combination of two or more thereof. The graft copolymer resin (c1) can include the vinyl cyanide monomer in an amount of about 1 to about 30% by weight, for example about 5 to about 25% by weight, based on the total weight of the graft copolymer resin (c1).

In another exemplary embodiment, a monomer for imparting workability and heat resistance may be added to the graft copolymer resin (c1). Examples of such monomer may include without limitation acrylic acid, methacrylic acid, maleic anhydride, N-substituted maleimide, and the like and may be used singly or in the form of a combination of two or more thereof. The graft copolymer resin (c1) can include the monomer added in the copolymerization for imparting workability and heat resistance in an amount of about 0 to about 15% by weight, for example about 1 to about 12% by weight, based on the total weight of the graft copolymer resin (c1).

(c2) Copolymer Resin

The copolymer resin (c2) of the present invention can be prepared according to the compatibility and a ratio of monomers except rubber in components of the graft copolymer resin (c1). The copolymer resin may be obtained by adding an aromatic vinyl monomer, a vinyl cyanide monomer, and optionally a monomer imparting workability and heat resistance and copolymerizing them.

Exemplary aromatic vinyl monomers may include without limitation styrene, α-methylstyrene, β-methylstyrene, p-methylstyrene, para-t-butylstyrene, ethylstyrene, vinyl xylene, monochlorostyrene, dichlorostyrene, dibromostyrene, vinylnaphthalene, and the like, and combinations thereof. The aromatic vinyl monomer is not necessarily limited thereto. The aromatic vinyl monomer may be used singly or in the form of a combination of two or more thereof. The copolymer resin (c2) may include the aromatic vinyl monomer in an amount of about 70 to about 95% by weight, for example about 75 to about 90% by weight, based on the total weight of the copolymer resin (c2).

Exemplary vinyl cyanide monomers may include without limitation vinyl cyanide compounds, such as acrylonitrile, ethacrylonitrile, methacrylonitrile and the like, and combinations thereof, and may be used singly or in the form of a combination of two or more thereof. The copolymer resin (c2) may include the vinyl cyanide monomer in an amount of about 5 to about 30% by weight, for example about 10 to about 27% by weight, based on the total weight of the copolymer resin (c2).

Exemplary monomers for imparting workability and heat resistance may include without limitation acrylic acid, methacrylic acid, maleic anhydride, N-substituted maleimide, and the like, and combinations thereof. The copolymer resin (c2) may include the monomer added in the copolymerization for imparting workability and heat resistance in an amount of about 0 to about 30% by weight, for example about 1 to about 25% by weight, based on the total weight of the copolymer resin (c2).

The resin composition according to the present invention may further comprise one or more additives, such as a flame retardant, a lubricant, a release agent, an antistatic agent, a dispersant, an anti-dripping agent, an impact modifier, an antioxidant, a plasticizer, a heat stabilizer, a light stabilizer, a weather resistant stabilizer, a compatibilizer, pigments, dyestuffs, an inorganic filler, and the like, and combinations thereof, in conventional amounts, if necessary. The additives may be used singly or in the form of a combination of two or more thereof.

The resin composition of the present invention may be prepared by well-known methods. For instance, after mixing the components of the present invention and other optionally additives, the mixture can be melted and extruded with an extruder, to manufacture pellets.

In an exemplary embodiment, the resin composition may be prepared by the steps of mixing about 1 to about 98 parts by weight of the recycled polyester resin, about 1 to about 80 parts by weight of the modified aromatic vinyl-vinyl cyanide copolymer resin comprising functional groups capable of reacting with polyester, and about 98 to about 1 part by weight of the aromatic vinyl graft copolymer resin, and extruding the mixture.

In an exemplary embodiment, a recycled polyester resin having an intrinsic viscosity of about 0.4 to about 1.5 g/dL is used. In another exemplary embodiment, when a polyester resin with an intrinsic viscosity of less than about 0.4 g/dL is used as a raw material, the recycled polyester resin may be used after controlling the intrinsic viscosity thereof to about 0.4 to about 1.5 g/dL by mixing a thickener with the polyester resin and extruding the mixture. The thickener may comprise a compound having two or more functional groups capable of reacting with a carboxyl group and a hydroxy group of polyester and can link polyester polymer chains. Exemplary functional groups include without limitation epoxy groups, maleic anhydride, maleic acid, amine groups, and the like, and combinations thereof. In an exemplary embodiment, the thickener may comprise triglycidyl isocyanurate. The thickener may be used in the amount of about 0.001 to about 5 parts by weight, for example about 0.005 to about 2.5 parts by weight, as another example about 0.01 to about 1 part by weight, based on about 100 parts by weight of recycled polyester. In an exemplary embodiment, after mixing recycled polyester with a thickener, the mixture is extruded at a temperature of about 160 to about 280° C. in an ordinary twin screw extruder to manufacture pellets so that the manufactured pellets can be used.

The composition of the present invention may be used for manufacturing various molded articles since the composition can have excellent impact resistance as well as chemical resistance. Examples of the molded articles include without limitation pellets, components of electric and electronic appliances, exterior materials, car components, miscellaneous goods, structural materials, and the like. The molded articles can be useful for exterior furnishings for electric and electronic products, housings for computers and other business machines, structural materials, and the like.

In an exemplary embodiment, the molded article can have an Izod impact strength of about 40 kgf·cm/cm or more measured in accordance with ASTM D-256 for a specimen with a thickness of ⅛″, and a cracking strain (ε) of the specimen can be 1.3% or more when engine oil is applied to a ¼ oval jig for about 24 hours.

The present invention will be well understood by the following examples. The following examples of the present invention are only for illustrative purposes and are not construed as being limited to the scope of the present invention defined by the appended claims.

### EXAMPLES

The components and additives used in the following Examples and Comparative Examples are as follows.

(A) Recycled Polyester Resin

(A1) Recycled Polyester Resin (Intrinsic Viscosity: about 0.4 g/dL or More When Obtaining Recycled Material)

A Clear PET Flake product manufactured by Samyang Corporation is used as a recycled polyester resin with an intrinsic viscosity of about 0.72 g/dL.

(A2) Recycled Polyester Resin (Intrinsic Viscosity: Below about 0.4 g/dL when Obtaining Recycled Material)

After uniformly mixing about 0.05 part by weight of triglycidyl isocyanurate manufactured by Aldrich Corporation as a thickener with about 100 parts by weight of a PET film-recycled material manufactured by Aju Environmental Industry Co., Ltd. as a recycled polyester resin having an intrinsic viscosity of about 0.35 g/dL in a Henschel mixer for about 3 to about 10 minutes, the mixture is extruded in an ordinary twin screw extruder at an extrusion temperature of about 250 to about 280° C., a screw rotational speed of about 150 to about 300 rpm, and a composition feed rate of about 30 to about 60 kg/hr to thereby prepare pellets. An intrinsic viscosity of the prepared pellets of the recycled polyester resin is about 0.62 g/dL.

(A3) Recycled Polyester Resin (Intrinsic Viscosity: Below about 0.4 g/dL when Obtaining Recycled Material)

After mixing about 0.2 part by weight of AUSIPOL PP-30, which is an epoxy-comprising polymer, manufactured by Polychem Chemicals sr1 as a thickener with about 100 parts by weight of a PET film-recycled material manufactured by Aju Environmental Industry Co., Ltd. as a recycled polyester resin having an intrinsic viscosity of about 0.35 g/dL, the mixture is extruded in an ordinary twin screw extruder at an extrusion temperature of about 180 to about 280° C., a screw rotational speed of about 150 to about 300 rpm, and a composition feed rate of about 30 to about 60 kg/hr to thereby prepare pellets. An intrinsic viscosity of the prepared pellets of the recycled polyester resin is about 0.68 g/dL.

(A4) Recycled Polyester Resin (Intrinsic Viscosity: Below about 0.4 g/dL when Obtaining Recycled Material)

A PET film-recycled material manufactured by Aju Environmental Industry Co., Ltd. is used as a recycled polyester resin having an intrinsic viscosity of about 0.35 g/dL.

(B) Modified Aromatic Vinyl-Vinyl Cyanide Copolymer Resin

(B1) Epoxy-Comprising SAN Resin (GMA 1.0%-SAN)

An epoxy-comprising styrene-acrylonitrile copolymer resin (GMA-SAN) is prepared by adding about 0.2 part by weight of azobisisobutyronitrile, about 0.4 part by weight of tricalcium phosphate and about 0.2 part by weight of a mercaptan-based chain transfer agent to a mixture of about 120 parts by weight of deionized water and about 100 parts by weight of a monomer mixture comprising about 1.0 mole % of glycidyl methacrylate and about 99.9 mole % of a vinyl-based compound comprising about 70 parts by weight of styrene and about 30 parts by weight of acrylonitrile, heating the resulting mixture from room temperature to about 80° C. for about 60 minutes, and then maintaining the resulting mixture at the temperature of about 80° C. for about 180 minutes. The prepared epoxy-comprising styrene-acrylonitrile copolymer resin is washed, dehydrated and dried to prepare a powdery epoxy-comprising styrene-acrylonitrile copolymer resin (GMA-SAN).

(B2) Carboxyl Group-Comprising Styrene-Based Resin (MAA 1.0%-SAN)

A carboxyl group-comprising styrene-acrylonitrile copolymer resin (MMA-SAN) is prepared by adding about 0.2 part by weight of azobisisobutyronitrile, about 0.4 part by weight of tricalcium phosphate and about 0.2 part by weight of a mercaptan-based chain transfer agent to a mixture of about 120 parts by weight of deionized water and about 100 parts by weight of a monomer mixture comprising about 1.0 mole % of methacrylic acid and about 99.0 mole % of a vinyl-based compound (B2) comprising about 70 parts by weight of styrene and about 30 parts by weight of acrylonitrile, heating the resulting mixture from room temperature to about 80° C. for about 60 minutes, and then, maintaining the resulting mixture at the temperature of about 80° C. for about 180 minutes. The prepared carboxyl group-comprising styrene-acrylonitrile copolymer resin is washed, dehydrated and dried to prepare a powdery carboxyl group-comprising styrene-acrylonitrile copolymer resin (MMA-SAN).

(B3) Maleic Anhydride-Comprising Styrene-Based Resin (MA 1.0%-SAN)

A maleic anhydride-comprising styrene-acrylonitrile copolymer resin (MA-SAN) is prepared by adding about 0.2 part by weight of azobisisobutyronitrile, about 0.4 part by weight of tricalcium phosphate and about 0.2 part by weight of a mercaptan-based chain transfer agent to a mixture of about 120 parts by weight of deionized water and about 100 parts by weight of a monomer mixture comprising about 1.0 mole % of maleic anhydride and about 99.0 mole % of a vinyl-based compound (B2) comprising about 70 parts by weight of styrene and about 30 parts by weight of acrylonitrile, heating the resulting mixture from room temperature to about 80° C. for about 60 minutes, and then, maintaining the resulting mixture at the temperature of about 80° C. for about 180 minutes. The prepared maleic anhydride-comprising styrene-acrylonitrile copolymer resin is washed, dehydrated and dried to prepare a powdery maleic anhydride-comprising styrene-acrylonitrile copolymer resin (MA-SAN).

(C) Aromatic Vinyl Graft Copolymer Resin

(c1) Graft Copolymer Resin

A graft copolymer (g-ABS) latex is prepared by preparing a mixture of about 50 parts by weight of the solid content of butadiene rubber latex, about 36 parts by weight of styrene, about 14 parts by weight of acrylonitrile, and about 150 parts by weight of deionized water, adding to the mixture about 1.0 part by weight of potassium oleate, about 0.4 part by weight of cumene hydroperoxide, about 0.2 part by weight of a mercaptan-based chain transfer agent, about 0.4 part by weight of glucose, about 0.01 part by weight of ferric sulfate hydrate, and about 0.3 part by weight of sodium pyrophosphate with respect to the total solid content of the mixture, and then, maintaining the resulting mixture to about 75° C. for five hours to complete the reaction. A powdery graft copolymer resin (g-ABS) is prepared by adding about 0.4 part by weight of sulfuric acid with respect to the solid content of the resulting resin composition thereto and by solidifying the mixture.

(c2) Copolymer Resin

A styrene-acrylonitrile copolymer resin (SAN resin) is prepared by adding about 0.2 part by weight of azobisisobutyronitrile, about 0.4 part by weight of tricalcium phosphate, and about 0.2 part by weight of a mercaptan-based chain transfer agent as required additives to a mixture of about 75 parts by weight of styrene, about 25 parts by weight of acrylonitrile, and about 120 parts by weight of deionized water, heating the resulting mixture from room temperature to about 80° C. for about 90 minutes, and then, maintaining the resulting mixture at the temperature of about 80° C. for about 180 minutes. The prepared styrene-acrylonitrile copolymer resin is washed, dehydrated and dried to prepare a powdery styrene-acrylonitrile copolymer resin (SAN resin).

### Examples 1 to 10

After adding the aforementioned components and hydroxyphenyl-based antioxidant as a heat stabilizer in the amounts as represented in the following Table 1, the components and hydroxyphenyl-based antioxidant are uniformly mixed in a Henschel mixer for about 3 to about 10 minutes. The mixture is extruded in an ordinary twin screw extruder at an extrusion temperature of about 180 to about 280° C., a screw rotational speed of about 150 to about 300 rpm, and a composition feed rate of about 30 to about 60 kg/hr to thereby prepare pellets. Specimens are manufactured by drying the prepared pellets at about 100° C. for about 4 hours and then injecting the dried pellets in an injection molding machine under the conditions of a molding temperature of about 180 to about 280° C. and a mold temperature of about 40 to about 80° C. After leaving alone the manufactured specimens at a temperature of about 23° C. and a relative humidity of about 50% for 40 hours, physical properties of the specimens are measured.

Methods for Measuring Physical Properties of Specimens

1) Impact strength (kgf·cm/cm): Impact strength of specimens with a thickness of ⅛″ is measured with the specimens notched in accordance with ASTM D256. An average of five test results is calculated as a final test result.

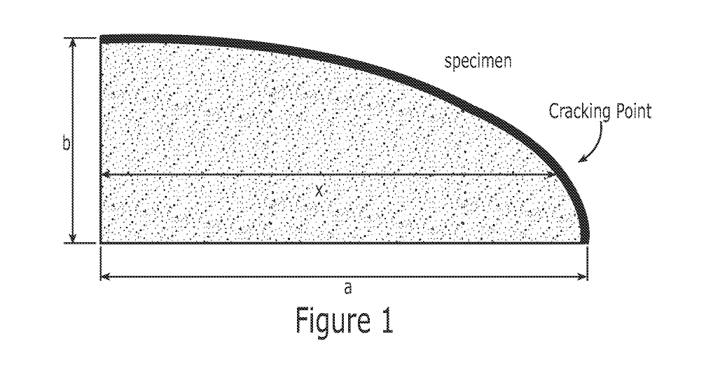

2) Chemical resistance: In order to evaluate chemical resistance to an organic solvent, cracking strain is obtained using Expression 1 from the cracking degree generated after mounting test specimens with dimensions of 200 mm×50 mm×2 mm (width×length×height) on ¼ oval jigs as illustrated in FIG. 1, coating the test specimens with an organic solvent, and allowing about 24 hours to pass.

ε=(b·t)/2a²×(1−x²(a²−b²)/a⁴)^{-3/2}×100(%) [Expression 1]

wherein:

ε: Cracking strain (%)

a: Length (mm) of the long axis of a measuring instrument

b: Length (mm) of the short axis of a measuring instrument

t: Thickness (mm) of specimen

x: Cracking length (mm) from the short axis

Examples of the used organic solvent include “Magic Clean” manufactured by Kao Corporation of Japan as an alkaline detergent, “Sunpole” manufactured by Dainihon Jochugiku Co., Ltd. of Japan as an acidic detergent, Brake Oil DOT4 manufactured by BOSCH as industrial oil, Phytoncide undiluted solution as an aromatic, and “Salad Oil” manufactured by Nissin Food Products Co., Ltd. of Japan as edible oil.

TABLE 1

| | | Example | | | | | | | | | |
|---|---|---|---|---|---|---|---|---|---|---|---|
| Composition | Mark | 1 | 2 | 3 | 4 | 5 | 6 | 7 | 8 | 9 | 10 |
| Recycled polyester | A1 | 40 | 40 | — | — | 40 | — | — | 40 | 30 | 50 |
| resin (A) | A2 | — | — | 40 | — | — | 40 | — | — | — | — |
| | A3 | — | — | — | 40 | — | — | 40 | — | — | — |
| | A4 | — | — | — | — | — | — | — | — | — | — |
| Modified aromatic | B1 | 25 | 40 | 25 | 25 | — | — | — | — | 25 | 25 |
| vinyl-vinyl cyanide | B2 | — | — | — | — | 25 | 25 | 25 | — | — | — |
| copolymer resin (B) | B3 | — | — | — | — | — | — | — | 25 | — | — |
| ABS resin (C) | C1 | 25 | 20 | 25 | 25 | 25 | 25 | 25 | 25 | 25 | 25 |
| | C2 | 10 | 0 | 10 | 10 | 10 | 10 | 10 | 10 | 20 | — |
| Heat stabilizer | | 0.3 | 0.3 | 0.3 | 0.3 | 0.3 | 0.3 | 0.3 | 0.3 | 0.3 | 0.3 |
| Impact strength (⅛″ kgf · cm/cm) | | 62 | 52 | 48 | 51 | 63 | 50 | 52 | 60 | 45 | 58 |
| Chemical resistance | Alkaline | NC | NC | NC | NC | NC | NC | NC | NC | NC | NC |
| | detergent | | | | | | | | | | |
| | Acidic detergent | NC | NC | NC | NC | NC | NC | NC | NC | NC | NC |
| | Industrial oil | 2.0 | 1.9 | 1.7 | 1.9 | 2.0 | 1.8 | 1.9 | 1.8 | 1.6 | 2.1 |
| | Aromatic | NC | NC | 2.1 | 2.2 | NC | 2.1 | 2.1 | NC | 2.0 | NC |
| | Edible oil | NC | NC | NC | NC | NC | NC | NC | NC | NC | NC |

* NC: No cracks (3% or more of cracking strain (ε))

### Comparative Examples 1 to 10

Specimens are manufactured in the same manner as in Examples 1 to 10 except that respective components are added to the amounts as represented in the following Table 2. Test results are represented in Table 2.

TABLE 2

| | | Comparative Example | | | | | | | | | |
|---|---|---|---|---|---|---|---|---|---|---|---|
| Composition | Marks | 1 | 2 | 3 | 4 | 5 | 6 | 7 | 8 | 9 | 10 |
| Recycled polyester | A1 | 40 | — | — | — | — | — | — | — | — | — |
| resin (A) | A2 | — | 40 | | — | — | — | — | — | — | — |
| | A3 | — | — | 40 | | — | — | — | — | — | — |
| | A4 | — | — | — | 40 | 40 | 40 | 40 | — | — | — |
| Modified aromatic | B1 | — | — | — | — | 25 | — | — | 25 | — | — |
| vinyl-vinyl cyanide | B2 | — | — | — | — | — | 25 | — | — | 25 | — |
| copolymer resin (B) | B3 | — | — | — | — | — | — | 25 | — | — | 25 |
| ABS resin (C) | C1 | 30 | 30 | 30 | 30 | 25 | 25 | 25 | 40 | 40 | 40 |
| | C2 | 30 | 30 | 30 | 30 | 10 | 10 | 10 | 35 | 35 | 35 |
| Heat stabilizer | | 0.3 | 0.3 | 0.3 | 0.3 | 0.3 | 0.3 | 0.3 | 0.3 | 0.3 | 0.3 |
| Impact strength (⅛″ kgf · cm/cm) | | 10 | 8 | 8 | 6 | 15 | 16 | 15 | 33 | 32 | 31 |
| Chemical | Alkaline | 1.6 | 1.6 | 1.5 | 1.3 | 1.7 | 1.7 | 1.7 | 1.3 | 1.3 | 1.3 |
| resistance | detergent | | | | | | | | | | |
| | Acidic detergent | 1.5 | 1.5 | 1.4 | 1.1 | 1.6 | 1.5 | 1.5 | 1.2 | 1.2 | 1.2 |
| | Industrial oil | 0.8 | 0.6 | 0.5 | 0.4 | 0.9 | 0.8 | 0.8 | 0.4 | 0.4 | 0.4 |
| | Aromatic | 1.2 | 0.9 | 0.9 | 0.8 | 1.3 | 1.2 | 1.2 | 0.6 | 0.6 | 0.6 |
| | Edible oil | 1.8 | 1.7 | 1.5 | 1.3 | 1.9 | 1.8 | 1.8 | 1.4 | 1.4 | 1.4 |

* NC: No cracks (3% or more of cracking strain (ε))

As represented in the foregoing Tables 1 and 2, Examples 1 to 10 using a recycled polyester resin with a specific viscosity range and a modified aromatic vinyl-vinyl cyanide copolymer resin can have excellent impact strength and chemical resistance. However, Comparative Examples 1 to 3 which include a recycled polyester resin with a specific viscosity range but do not include a modified aromatic vinyl-vinyl cyanide copolymer resin, exhibit lowered impact strength and chemical resistance. Also, Comparative Example 4 which does not include either the recycled polyester resin with a specific viscosity range nor the modified aromatic vinyl-vinyl cyanide copolymer resin has the lowest impact strength and chemical resistance. Comparative Examples 5 to 7 demonstrate that a balance of physical properties such as impact strength and chemical resistance cannot be obtained if the recycled polyester resin has a low intrinsic viscosity although a compatibilizer of the present invention is applied. In addition, the chemical resistance of Comparative Examples 8 to 10 in which the recycled polyester resin is not used is remarkably deteriorated.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. An environmentally sound thermoplastic resin composition, comprising:
(A) about 1 to about 98 parts by weight of a recycled polyester resin;
(B) about 1 to about 80 parts by weight of a modified aromatic vinyl-vinyl cyanide copolymer resin; and
(C) about 98 to about 1 part by weight of an aromatic vinyl graft copolymer resin.

2. The environmentally sound thermoplastic resin composition of claim 1, wherein the recycled polyester resin (A) has an intrinsic viscosity of about 0.4 to about 1.5 g/dL.

3. The environmentally sound thermoplastic resin composition of claim 1, wherein said modified aromatic vinyl-vinyl cyanide copolymer resin (B) is a copolymer of (b1) about 0.01 to about 5 mole % of maleic anhydride, maleic acid, an unsaturated compound represented by the following Chemical Formula 1, or a combination thereof; and (b2) about 95 to about 99.99 mole % of a vinyl-based compound: 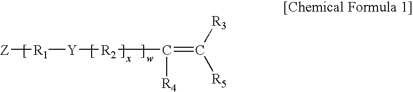
wherein each of R₃, R₄ and R₅ independently comprises H, saturated or unsaturated C1-C12 alkyl, C6-C14 aryl, saturated or unsaturated C1-C12 alkyl-substituted C6-C14 aryl, carboxyl, phenoxy, or hydroxy;
Y is ether (—O—), carboxyl (—O—[C═O]—, —[O═C]—O—), C1-C12 alkylene, C6-C14 arylene, or saturated or unsaturated C1-C12 alkyl-substituted C6-C14 arylene;
each of x and w is independently 0 or 1;
Z is H, epoxy, carboxylic acid, isocyanate, oxadiazole, amine, or hydroxy,
wherein if Y is ether (—O—) or carboxyl (—O—[C═O]—, —[O═C]—O—), each R₁ and R₂ independently comprises C1-C12 alkylene, C6-C14 arylene, or saturated or unsaturated C1-C12 alkyl-substituted C6-C14 arylene,
and if Y is C1-C12 alkylene, C6-C14 arylene, or saturated or unsaturated alkyl-substituted C6-C14 arylene, Y is represented by (R₁—Y—R₂).

4. The environmentally sound thermoplastic resin composition of claim 3, wherein said unsaturated compound comprises an epoxy group-comprising monomer; a carboxylic acid group-comprising monomer; an isocyanate group-comprising monomer; an amine group-comprising monomer; a hydroxy group-comprising monomer; or a combination thereof.

5. The environmentally sound thermoplastic resin composition of claim 4, wherein said epoxy group-comprising monomer comprises epoxy alkyl acrylate, allyl glycidyl ester, aryl glycidyl ester, glycidyl methacrylate, glycidyl acrylate, butadiene monoxide, vinyl glycidyl ether, glycidyl itaconate, or a combination thereof; said carboxylic acid group-comprising monomer comprises acrylic acid, methacrylic acid, 2-butenoic acid, 2-methyl-2-butenoic acid, undecylenic acid, oleic acid, sorbic acid, linoleic acid, crotonic acid, itaconic acid, or a combination thereof; said isocyanate group-comprising monomer comprises vinyl isocyanate, acryl isocyanate, methacryl isocyanate, or a combination thereof; said amine group-comprising monomer comprises vinyl amine, acryl amine, methacryl amine, or a combination thereof; and said hydroxy group-comprising monomer comprises hydroxy vinyl ether, hydroxy ethyl acrylate, hydroxy ethyl methacrylate, hydroxy propyl acrylate, hydroxy propyl methacrylate, 2-hydroxy-3-phenoxypropyl acrylate, or a combination thereof.

6. The environmentally sound thermoplastic resin composition of claim 1, wherein the aromatic vinyl graft copolymer resin (C) comprises (c1) about 10 to about 100% by weight of a graft copolymer resin and (c2) about 0 to about 90% by weight of a copolymer resin.

7. The environmentally sound thermoplastic resin composition of claim 6, wherein said graft copolymer resin (c1) is a graft copolymer obtained by polymerizing about 5 to about 65% by weight of a rubber-like polymer with a monomer mixture comprising about 34 to about 94% by weight of an aromatic vinyl monomer and about 1 to about 30% by weight of a vinyl cyanide monomer; and
said copolymer resin (c2) is a copolymer obtained by polymerizing a monomer mixture comprising about 70 to about 95% by weight of an aromatic vinyl monomer and about 5 to about 30% by weight of a vinyl cyanide monomer.

8. The environmentally sound thermoplastic resin composition of claim 1, wherein the resin composition further comprises a thickener.

9. The environmentally sound thermoplastic resin composition of claim 8, comprising said thickener in an amount of about 0.001 to about 5 parts by weight based on about 100 parts by weight of the recycled polyester.

10. The environmentally sound thermoplastic resin composition of claim 8, wherein said thickener has two or more functional groups comprising an epoxy group, maleic anhydride, maleic acid, an amine group, or a combination thereof.

11. The environmentally sound thermoplastic resin composition of claim 1, wherein the resin composition further comprises one or more additives comprising a flame retardant, a lubricant, a release agent, an antistatic agent, a dispersant, an anti-dripping agent, an impact modifier, an antioxidant, a plasticizer, a heat stabilizer, a light stabilizer, a weather resistant stabilizer, a compatibilizer, a pigment, a dyestuff, an inorganic filler, or a combination thereof.

12. A molded article produced from the thermoplastic resin composition as defined in claim 1.

13. The molded article of claim 12, wherein the molded article has an Izod impact strength of about 40 kgf·cm/cm or more measured in accordance with ASTM D-256 at a thickness of ⅛″, and a cracking strain (ε) of the molded article calculated by the following Expression 1 is about 1.3% or more when engine oil is applied to a ¼ oval jig for about 24 hours:
ε=(b·t)/2a²×(1−x²(a²−b²)/a⁴)^{-3/2}×100(%) [Expression 1]
ε: Cracking strain (%)
a: Length (mm) of the long axis of a measuring instrument
b: Length (mm) of the short axis of a measuring instrument
t: Thickness (mm) of specimen
x: Cracking length (mm) from the short axis.
